(19) United States
(12) Patent Application Publication
(10) Pub. No.: US 2026/0162916 A1
(43) Pub. Date: Jun. 11, 2026

(54) BUTTON STRUCTURE

(71) Applicant: CHENG UEI PRECISION INDUSTRY CO., LTD., New Taipei City (TW)

(72) Inventor: TSUNG-SHIH LEE, New Taipei City (TW)

(21) Appl. No.: 19/050,111

(22) Filed: Feb. 10, 2025

(30) Foreign Application Priority Data
Aug. 16, 2024 (CN) 202421998303.2

(51) Int. Cl. H01H 13/04; H01H 9/02; H01H 13/10; H01H 13/14; H01H 13/36

(52) U.S. Cl. CPC H01H 13/04; H01H 9/0271; H01H 13/10; H01H 13/14; H01H 13/36

(57) ABSTRACT

A button structure includes an upper cover, a lower cover disposed under the upper cover, and a pressing button. An inner surface of the upper cover has at least two blocking walls. The pressing button is disposed between the upper cover and the lower cover. The pressing button has a main portion. A front end of the main portion extend frontward, then are oppositely arched outward and further extend frontward to form two elastic arms. The two elastic arms abut against the two blocking walls. A connecting arm is connected between two front ends of the two elastic arms. The connecting arm abuts against the inner surface of the upper cover. The front end of the main portion extends frontward to form an extending portion. The extending portion abuts against a switch.

### CROSS REFERENCE TO RELATED APPLICATIONS

The present application is based on, and claims priority from, China Patent Application No. 202421998303.2, filed Aug. 16, 2024, the disclosure of which is hereby incorporated by reference herein in its entirety.

### BACKGROUND OF THE INVENTION

### Field of the Invention

The present invention generally relates to a button structure, and more particularly to a button structure having a better assembling stability.

### Description of Related Art

A power button is a standard component in a game controller. The power button abuts against a switch of a circuit board. When the power button is pressed downward, the power button triggers the switch. The game controller executes a corresponding action. When the power button is released, the power button is returned to an initial position by an elastic force of the switch of the circuit board.

A conventional power button is applied to a projector. The conventional power button is a slot type. The conventional power button includes an assembling board, a hinging block, a strap-shaped lamp bracket, a strap-shaped light source and a connecting shaft. The conventional power button is cooperated with a first mounting portion of a mounting surface. The conventional power button is connected with the first mounting portion of the mounting surface. The conventional power button includes a button body, an elastic arm and a second mounting portion. The button body is connected with the second mounting portion by the elastic arm. The second mounting portion is connected with the first mounting portion by an inserting way.

However, a gap is formed between the first mounting portion and the second mounting portion of the conventional power button due to a manufacturing tolerance factor. When the conventional power button is used, the conventional power button is easy to shake, and a hand feeling is affected.

Thus, it is essential to provide an innovative button structure, the button structure having a better assembling stability.

### BRIEF SUMMARY OF THE INVENTION

An object of the present invention is to provide a button structure cooperated with a circuit board. The circuit board is equipped with a switch. The button structure includes an upper cover, a lower cover disposed under the upper cover, and a pressing button. An inner surface of the upper cover has at least two blocking walls. The pressing button is disposed between the upper cover and the lower cover. The pressing button has a main portion. A front end of the main portion extend frontward, then are oppositely arched outward and further extend frontward to form two elastic arms. The two elastic arms abut against the two blocking walls. A connecting arm is connected between two front ends of the two elastic arms. The connecting arm abuts against the inner surface of the upper cover. The front end of the main portion extends frontward to form an extending portion. The extending portion is positioned between the two elastic arms and the connecting arm. The extending portion abuts against the switch. A top surface of the main portion protrudes upward to form a pressing portion. The pressing portion projects beyond an outer surface of the upper cover.

Another object of the present invention is to provide a button structure cooperated with a circuit board. The circuit board is equipped with a switch. The button structure includes an upper cover, a lower cover and a pressing button. An inner surface of the upper cover has two blocking walls. The lower cover is positioned under the upper cover. The pressing button is disposed between the upper cover and the lower cover. The pressing button has a main portion. A front end of the main portion extends frontward to form two first extending arms, respectively. Two front ends of the two first extending arms are bent outward and then are bent inward to form two bending portions. The two bending portions abut against the two blocking walls. Two front ends of the two bending portions extend frontward to form two second extending arms. A connecting arm is connected between two front ends of the two second extending arms. The connecting arm abuts against the inner surface of the upper cover. The front end of the main portion extends frontward to form an extending portion. The extending portion is positioned among the two first extending arms, the two bending portions, the two second extending arms and the connecting arm. The extending portion abuts against the switch. A top surface of the main portion protrudes upward to form a pressing portion. The pressing portion projects beyond an outer surface of the upper cover.

Another object of the present invention is to provide a button structure. The button structure includes a main portion, an extending portion extended frontward from a middle of a front end of the main portion, two elastic arms, a connecting arm and a pressing portion. The two elastic arms are extended frontward, then are oppositely arched outward and are further extended frontward from two opposite sides of the front end of the main portion. Each elastic arm has a first extending arm, a bending portion and a second extending arm. The two opposite sides of the front end of the main portion extend frontward to form the two first extending arms of the two elastic arms, respectively. A front end of each first extending arm is bent outward and then is bent inward to form the bending portion. A front end of each bending portion extends frontward to form the second extending arm. The connecting arm is formed between two front ends of the two second extending arms of the two elastic arms. The pressing portion is extended upward from a top surface of the main portion.

As described above, the two bending portions of the pressing button of the button structure abut against the two blocking walls of the upper cover, so the two bending portions prevent the pressing button from swaying laterally. Furthermore, a first protruding portion of the pressing button abuts against a first protrusion of the upper cover, so that the first protruding portion of the pressing button prevents the pressing button from swaying upward. In addition, a second protruding portion of the pressing button abuts against the switch of the circuit board, so the second protruding portion of the pressing button prevents the pressing button from swaying downward. As a result, the pressing button of the button structure is assembled stably, and the button structure has a better assembling stability.

### BRIEF DESCRIPTION OF THE DRAWINGS

The present invention will be apparent to those skilled in the art by reading the following description, with reference to the attached drawings, in which:

FIG. 1 is an assembling view of a button structure and a circuit board in accordance with a preferred embodiment of the present invention;

FIG. 2 is an exploded view of the button structure and the circuit board according to the preferred embodiment of the present invention;

FIG. 3 is a diagrammatic drawing of the button structure and the circuit board according to the preferred embodiment of the present invention;

FIG. 4 is a sectional diagram of the button structure along a line IV-IV of FIG. 3;

FIG. 5 is a perspective view of the button structure of FIG. 1;

FIG. 6 is an exploded view of the button structure of FIG. 5;

FIG. 7 is another exploded view of the button structure of FIG. 5;

FIG. 8 is a perspective view of a pressing button of the button structure of FIG. 5;

FIG. 9 is an enlarged view of an encircled portion X1 of the button structure of FIG. 5;

FIG. 10 is a diagrammatic drawing of the button structure of FIG. 5; and

FIG. 11 is a sectional diagram of the button structure along a line XI-XI of FIG. 10.

### DETAILED DESCRIPTION OF THE INVENTION

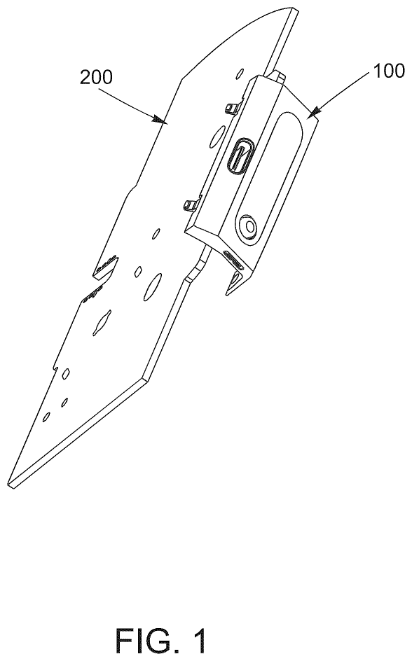

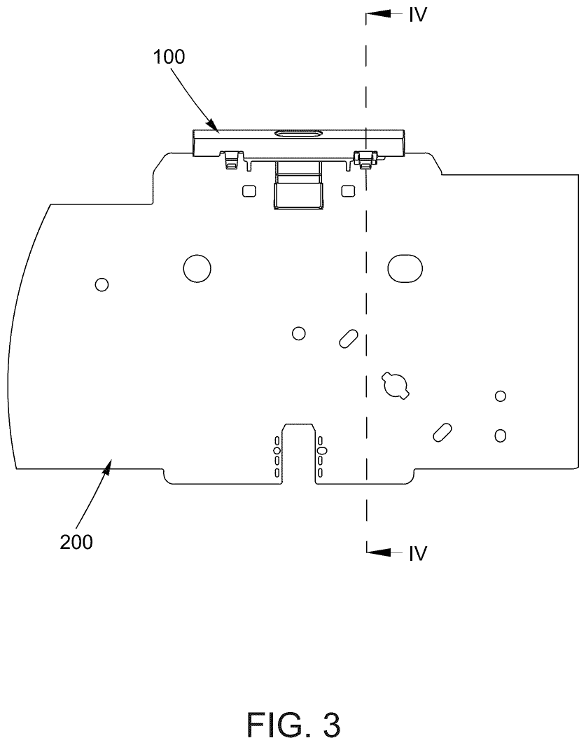

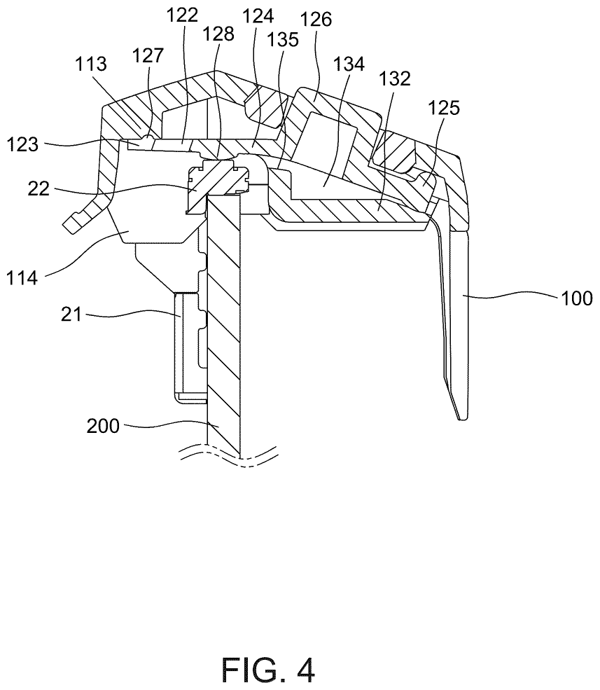

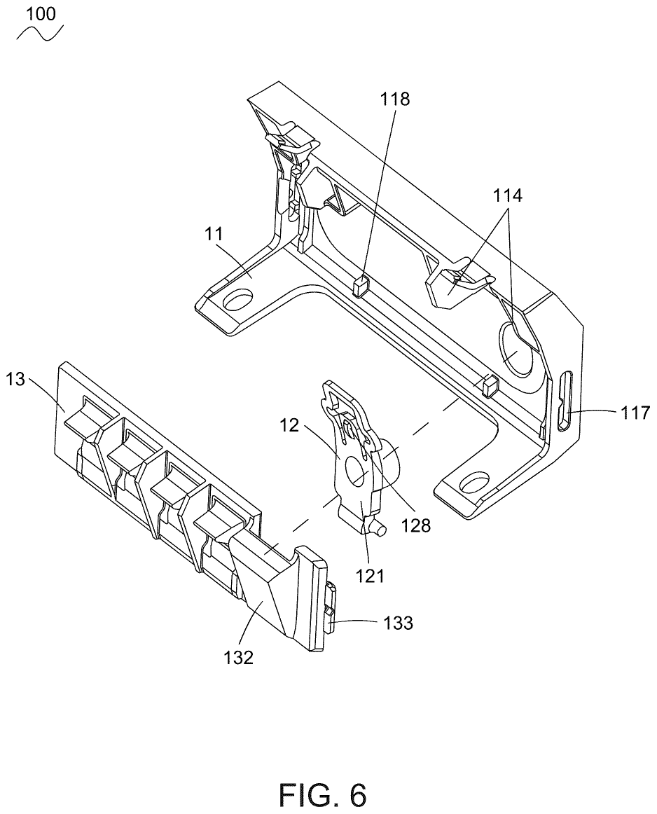

With reference to FIG. 1 to FIG. 6, a button structure 100 according to a preferred embodiment of the present invention is shown. The button structure 100 is cooperated with a circuit board 200. The button structure 100 is disposed to a top of the circuit board 200. The button structure 100 includes an upper cover 11, a pressing button 12, and a lower cover 13 disposed to a bottom of the upper cover 11. The upper cover 11 is disposed to a top surface of the pressing button 12. The lower cover 13 has an upper surface 130. The pressing button 12 is disposed to the upper surface 130 of the lower cover 13. The pressing button 12 is disposed between the upper cover 11 and the lower cover 13.

The upper cover 11 is disposed to the top of the circuit board 200. The upper cover 11 has a base portion 111 and an inclining portion 112. One end of the base portion 111 slantwise extends outward and downward to form the inclining portion 112. In the preferred embodiment, the base portion 111 is positioned at a rear of the circuit board 200. The inclining portion 112 is positioned at a front of the circuit board 200. The pressing button 12 is disposed to a bottom surface of the base portion 111 and a bottom surface of the inclining portion 112. The lower cover 13 is mounted to the bottom surface of the base portion 111. The lower cover 13 is positioned at the rear of the circuit board 200.

The upper cover 11 has a first protrusion 113, two blocking walls 114, a through hole 115, a button hole 116, two location holes 117 and two second protrusions 118. Preferably, the upper cover 11 has a plurality of second protrusions 118. The inner surface of the upper cover 11 extends downward to form the first protrusion 113. An inner surface of the inclining portion 112 of the upper cover 11 extends downward to form the first protrusion 113. A corresponding mechanism of the pressing button 12 abuts against the first protrusion 113 to realize that the pressing button 12 is located to the upper cover 11, and that the pressing button 12 is fastened to the upper cover 11. Two portions of the inner surface of the inclining portion 112 of the upper cover 11 extend downward to form the two blocking walls 114. The first protrusion 113 is disposed between the two blocking walls 114. Two corresponding sections of the pressing button 12 abut against the two blocking walls 114 to realize that the pressing button 12 is located to the upper cover 11, and the pressing button 12 is fastened to the upper cover 11. The through hole 115 penetrates through middles of a top surface and the bottom surface of the inclining portion 112 of the upper cover 11. A corresponding zone of the circuit board 200 is disposed in the through hole 115.

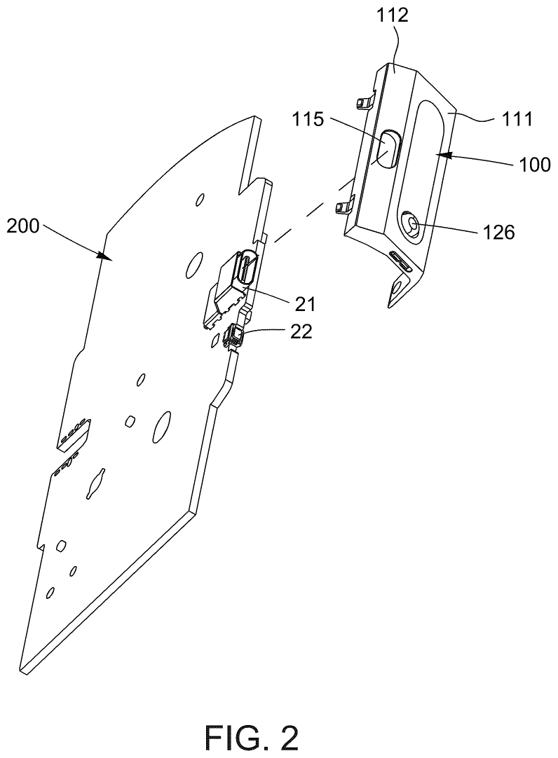

Referring to FIG. 2 to FIG. 7, the button hole 116 penetrates through a top surface and the bottom surface of the base portion 111 of the upper cover 11. A corresponding area of the pressing button 12 is disposed in the button hole 116 to realize that the pressing button 12 is located to the upper cover 11, and that the pressing button 12 is fastened to the upper cover 11. The two location holes 117 transversely penetrate through two opposite side surfaces of the base portion 111 of the upper cover 11. Corresponding mechanisms of the lower cover 13 are disposed in the two location holes 117 to realize that the lower cover 13 is located to the upper cover 11, and the lower cover 13 is fastened to the upper cover 11. Two sides of an inner surface of the base portion 111 of the upper cover 11 protrude inward to form the two second protrusions 118. Preferably, the inner surface of the base portion 111 of the upper cover 11 extends inward to form the plurality of the second protrusions 118. A corresponding mechanism of the lower cover 13 abuts against the plurality of the second protrusions 118.

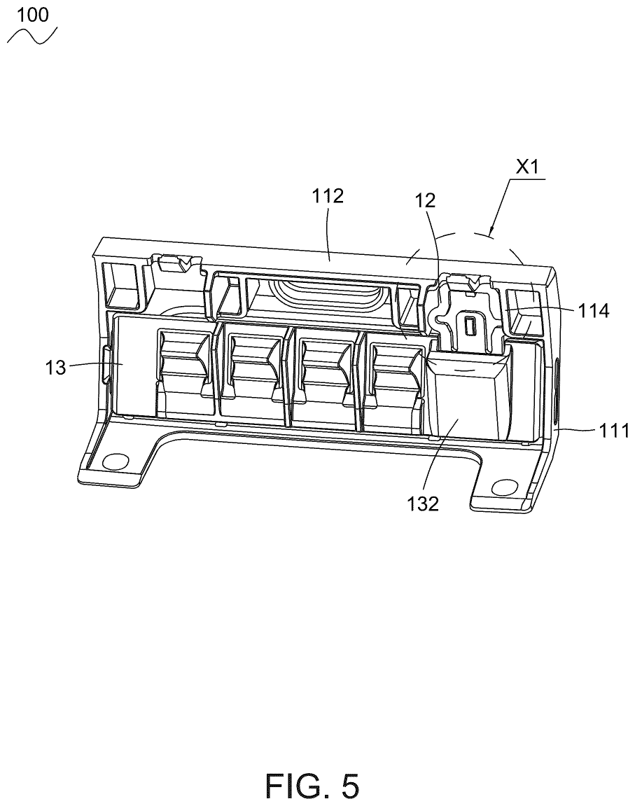

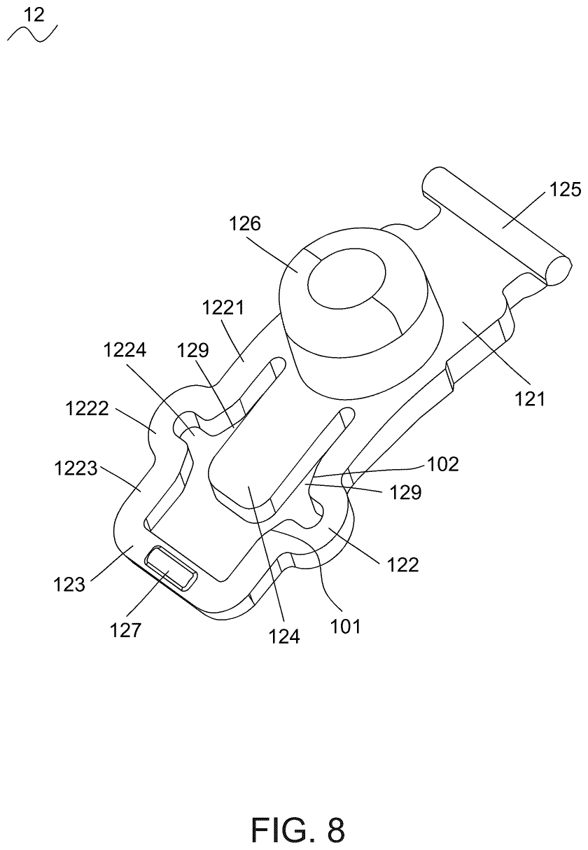

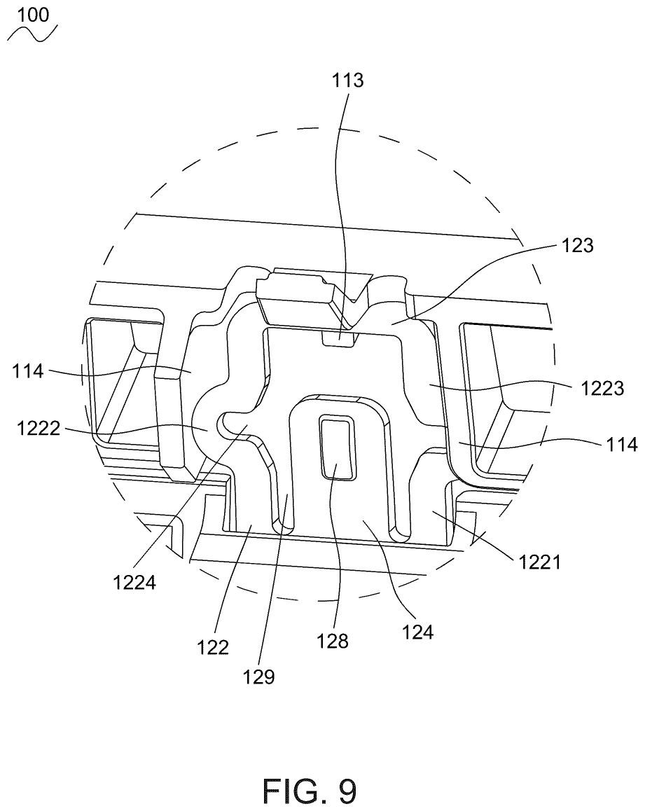

Referring to FIG. 5, FIG. 8 and FIG. 9, the pressing button 12 has a main portion 121, two elastic arms 122, a connecting arm 123, an extending portion 124 extended frontward from a middle of a front end of the main portion 121, a fastening portion 125, a pressing portion 126 extended upward from a top surface of the main portion 121, a first protruding portion 127 and a second protruding portion 128. The main portion 121 is disposed to the bottom surface of the base portion 111 of the upper cover 11. The middle of the front end of the main portion 121 extends frontward to form the extending portion 124. The two elastic arms 122 are extended frontward, then are oppositely arched outward and are further extended frontward from two opposite sides of the front end of the main portion 121.

The two opposite sides of the front end of the main portion 121 extend frontward, then are oppositely arched outward and further extend frontward to form the two elastic arms 122. Two middles of the two elastic arms 122 are shown as two arc shapes. An inner surface of a front end of the middle of each elastic arm 122 slantwise extends frontward and inward to form a first inclining surface 101. An inner surface of a rear end of the middle of each elastic arm 122 slantwise extends rearward and inward to form a second inclining surface 102. The two elastic arms 122 are disposed to two sides of a junction between the bottom surface of the base portion 111 and the bottom surface of the inclining portion 112 of the upper cover 11. The two elastic arms 122 abut against the two blocking walls 114 of the upper cover 11 to realize that the pressing button 12 is located to the upper cover 11, and the pressing button 12 is fastened to the upper cover 11. The two elastic arms 122 prevent the pressing button 12 from swaying laterally.

Two free ends of the two elastic arms 122 extend towards each other to form the connecting arm 123. The connecting arm 123 is formed between the two free ends of the two elastic arms 122. The connecting arm 123 is formed between two front ends of the two elastic arms 122. The connecting arm 123 is disposed to the bottom surface of the inclining portion 112 of the upper cover 11. The connecting arm 123 is corresponding to the first protrusion 113 of the upper cover 11. The connecting arm 123 is disposed to a bottom of the first protrusion 113 of the upper cover 11. The connecting arm 123 abuts against the bottom of the first protrusion 113 of the upper cover 11. The connecting arm 123 abuts against the inner surface of the upper cover 11. The extending portion 124 is formed between the two elastic arms 122 and the connecting arm 123. The pressing button 12 defines a penetrating groove 129 penetrating through a top surface and a bottom surface of the pressing button 12. The penetrating groove 129 is formed among the two elastic arms 122, the connecting arm 123 and the extending portion 124. The penetrating groove 129 is used for providing an elastic deformation space of the two elastic arms 122. When the two elastic arms 122 abut against the two blocking walls 114 of the upper cover 11, the two elastic arms 122 are squeezed by the two blocking walls 114 of the upper cover 11, and the two elastic arms 122 are deformed towards the extending portion 124.

Each elastic arm 122 has a first extending arm 1221, a bending portion 1222 and a second extending arm 1223. The penetrating groove 129 is formed among the two elastic arms 122, the connecting arm 123 and the extending portion 124. The penetrating groove 129 is formed among the two first extending arms 1221, the two bending portions 1222, the two second extending arms 1223, the connecting arm 123 and the extending portion 124. The two opposite sides of the front end of the main portion 121 extend frontward to form the two first extending arms 1221 of the two elastic arms 122, respectively. A front end of each first extending arm 1221 is bent outward and then is bent inward to form the bending portion 1222, so the two front ends of the two first extending arms 1221 are bent outward and then are bent inward to form the two bending portions 1222 of the two elastic arms 122. The two bending portions 1222 of the two elastic arms 122 of the pressing button 12 abut against the two blocking walls 114 of the upper cover 11 to realize that the pressing button 12 is located to the upper cover 11, and the pressing button 12 is fastened to the upper cover 11. The two bending portions 1222 of the pressing button 12 prevent the pressing button 12 from swaying laterally.

A front end of each bending portion 1222 extends frontward to form the second extending arm 1223, so the two front ends of the two bending portions 1222 extend frontward to form the two second extending arms 1223 of the two elastic arms 122. The connecting arm 123 is formed between two front ends of the two second extending arms 1223 of the two elastic arms 122. The front ends of the two second extending arms 1223 are connected with the connecting arm 123 of the pressing button 12. The extending portion 124 is formed among the two first extending arms 1221, the two bending portions 1222, the two second extending arms 1223 and the connecting arm 123. Two inner surfaces of the two bending portions 1222 are recessed oppositely to form two lacking grooves 1224. In the preferred embodiment, each lacking groove 1224 is located between one bending portion 1222 and the extending portion 124 of the pressing button 12. The two lacking grooves 1224 are used for providing the elastic deformation space of the two bending portions 1222. The two lacking grooves 1224 are communicated with the penetrating groove 129 of the pressing button 12. When the two bending portions 1222 abut against the two blocking walls 114 of the upper cover 11, the two bending portions 1222 are squeezed to be deformed towards the extending portion 124.

The extending portion 124 of the pressing button 12 is disposed to the bottom surface of the base portion 111 and the bottom surface of the inclining portion 112 of the upper cover 11. A rear end of the main portion 121 protrudes upward to form the fastening portion 125. The fastening portion 125 is disposed to the upper surface 130 of the lower cover 13. The fastening portion 125 abuts against the inner surface of the base portion 111 of the upper cover 11. The top surface of the main portion 121 protrudes upward to form the pressing portion 126. The pressing portion 126 is disposed in the button hole 116 of the upper cover 11. The pressing portion 126 projects beyond an outer surface of the upper cover 11.

A middle of a top surface of the connecting arm 123 of the pressing button 12 extends upward to form the first protruding portion 127. The first protruding portion 127 of the pressing button 12 abuts against the first protrusion 113 of the upper cover 11 to realize that the pressing button 12 is located to the upper cover 11, and that the pressing button 12 is fastened to the upper cover 11. The first protruding portion 127 of the pressing button 12 prevents the pressing button 12 from swaying upward.

A front end of a bottom surface of the extending portion 124 of the pressing button 12 extends downward to form the second protruding portion 128. The second protruding portion 128 of the pressing button 12 abuts against a corresponding position of the circuit board 200 to realize that the button structure 100 is located to the circuit board 200, and that the button structure 100 is fastened to the circuit board 200. The second protruding portion 128 of the pressing button 12 prevents the pressing button 12 from swaying downward.

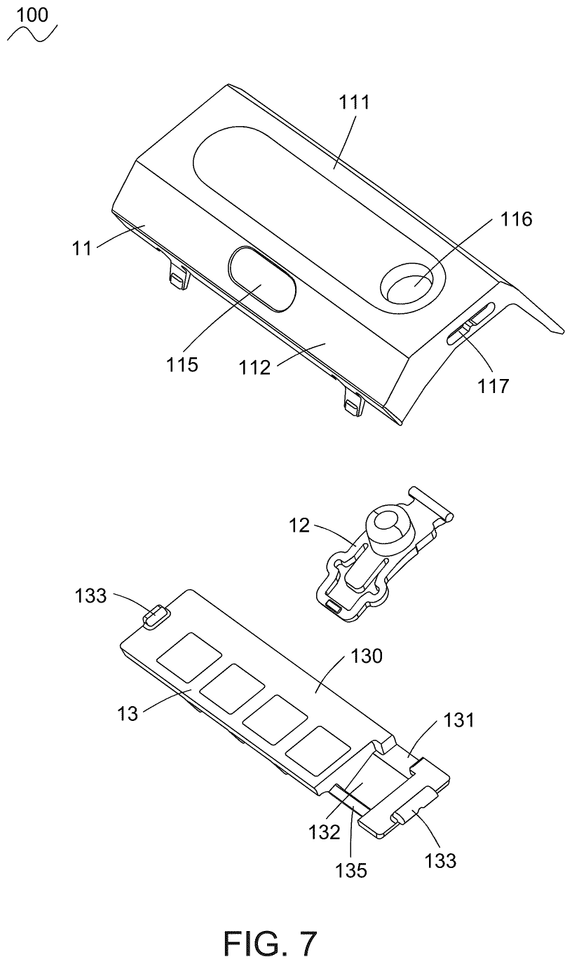

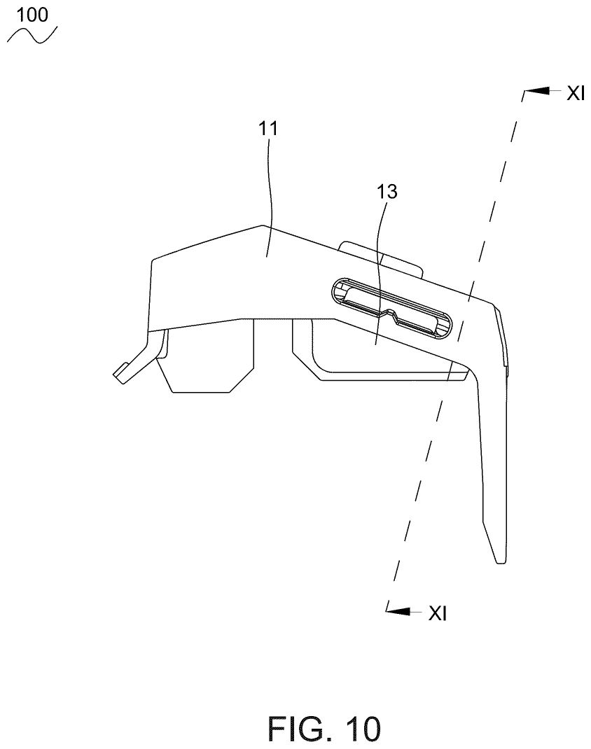

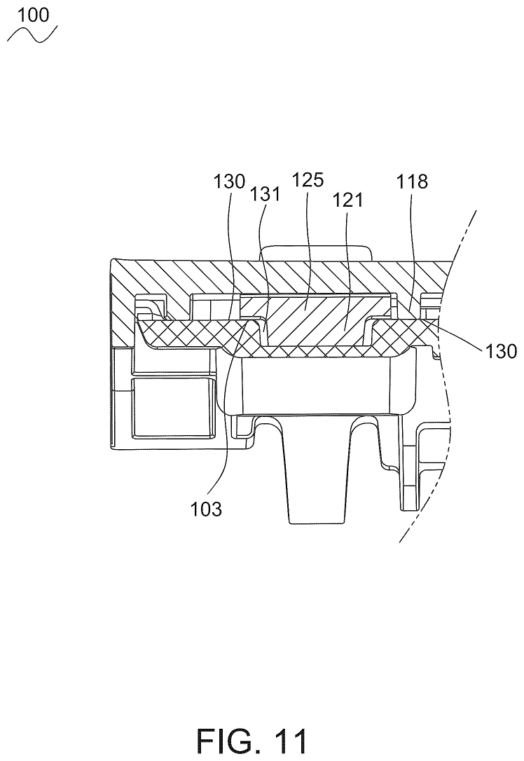

Referring to FIG. 7 to FIG. 11, the lower cover 13 has the upper surface 130, a first concave portion 131, a second concave portion 132, two location portions 133 and a stopping portion 135. The upper surface 130 of the lower cover 13 abuts against the two second protrusions 118 of the upper cover 11, preferably, the upper surface 130 abuts against the plurality of the second protrusions 118 of the upper cover 11, so an accommodating space 103 is formed between the upper cover 11 and the lower cover 13. The accommodating space 103 is used for receiving the fastening portion 125 of the pressing button 12. The fastening portion 125 of the pressing button 12 is disposed to the upper surface 130 of the lower cover 13. The fastening portion 125 of the pressing button 12 is disposed to one side of the second protrusions 118 of the upper cover 11. A rear end of one side of the upper surface 130 of the lower cover 13 is recessed downward to form the first concave portion 131. The rear end of the main portion 121 of the pressing button 12 is disposed in the first concave portion 131. The fastening portion 125 of the pressing button 12 is disposed to a top of the first concave portion 131.

The one side of the upper surface 130 of the lower cover 13 is recessed downward to form the second concave portion 132. The second concave portion 132 is located in front of the first concave portion 131. The second concave portion 132 is communicated with the first concave portion 131. The main portion 121 of the pressing button 12 is disposed to a top of the second concave portion 132.

The main portion 121 of the pressing button 12 is covered to the top of the second concave portion 132, so an interval 134 is formed between the main portion 121 of the pressing button 12 and the second concave portion 132. A front end of a bottom wall of the second concave portion 132 extends upward to form the stopping portion 135. The pressing portion 126 of the pressing button 12 is disposed above the stopping portion 135. When the pressing button 12 is pressed downward, the main portion 121 of the pressing button 12 is deformed towards the second concave portion 132. The interval 134 is served as an avoiding space when the main portion 121 is deformed.

When the pressing button 12 is pressed downward, the pressing portion 126 of the pressing button 12 abuts against the stopping portion 135. The stopping portion 135 is used for preventing the pressing portion 126 from being continuously pressed downward to cause a damage of the pressing button 12. The two elastic arms 122 of the pressing button 12, the connecting arm 123 of the pressing button 12 and the extending portion 124 of the pressing button 12 project beyond the stopping portion 135. The two elastic arms 122, the connecting arm 123 and the extending portion 124 are positioned under the bottom surface of the inclining portion 112. The two first extending arms 1221, the two bending portions 1222, the two second extending arms 1223, the connecting arm 123 and the extending portion 124 are positioned under the bottom surface of the inclining portion 112. The two elastic arms 122 of the pressing button 12, the connecting arm 123 of the pressing button 12 and the extending portion 124 of the pressing button 12 are exposed out of a front end of the lower cover 13.

Two opposite sides of the upper surface 130 of the lower cover 13 extend upward to form the two location portions 133, respectively. The two location portions 133 are disposed in the two location holes 117 of the base portion 111 of the upper cover 11 to realize that the lower cover 13 is located to the upper cover 11, and that the lower cover 13 is fastened to the upper cover 11.

Referring to FIG. 1 to FIG. 11, a front surface of an upper end of the circuit board 200 is equipped with an interface 21 and a switch 22. The interface 21 is inserted into the through hole 115 of the upper cover 11 to realize that the button structure 100 is located to the circuit board 200, and that the button structure 100 is fastened to the circuit board 200. The extending portion 124 of the pressing button 12 is corresponding to the switch 22. The second protruding portion 128 of the extending portion 124 of the pressing button 12 abuts against the switch 22 of the circuit board 200 to realize that the button structure 100 is located to the circuit board 200, and that the button structure 100 is fastened to the circuit board 200. The second protruding portion 128 prevents the pressing button 12 from swaying downward. When the pressing portion 126 of the pressing button 12 is pressed downward, the second protruding portion 128 presses downward on the switch 22.

As described above, the two bending portions 1222 of the pressing button 12 of the button structure 100 abut against the two blocking walls 114 of the upper cover 11, so the two bending portions 1222 prevent the pressing button 12 from swaying laterally. Furthermore, the first protruding portion 127 of the pressing button 12 abuts against the first protrusion 113 of the upper cover 11, so that the first protruding portion 127 of the pressing button 12 prevents the pressing button 12 from swaying upward. In addition, the second protruding portion 128 of the pressing button 12 abuts against the switch 22 of the circuit board 200, so the second protruding portion 128 of the pressing button 12 prevents the pressing button 12 from swaying downward. As a result, the pressing button 12 of the button structure 100 is assembled stably, and the button structure 100 has a better assembling stability.

What is claimed is:

1. A button structure cooperated with a circuit board, the circuit board being equipped with a
switch, the button structure comprising:
an upper cover, an inner surface of the upper cover having at least two blocking walls;
a lower cover disposed under the upper cover; and
a pressing button disposed between the upper cover and the lower cover, the pressing button having a main portion, a front end of the main portion extending frontward, then being oppositely arched outward and further extending frontward to form two elastic arms, the two elastic arms abutting against the two blocking walls, a connecting arm being connected between two front ends of the two elastic arms, the connecting arm abutting against the inner surface of the upper cover, the front end of the main portion extending frontward to form an extending portion, the extending portion being positioned between the two elastic arms and the connecting arm, the extending portion abutting against the switch, a top surface of the main portion protruding upward to form a pressing portion, the pressing portion projecting beyond an outer surface of the upper cover.

2. The button structure as claimed in claim 1, wherein each elastic arm has a first extending arm, a bending portion and a second extending arm, two opposite sides of the front end of the main portion extend frontward to form the two first extending arms of the two elastic arms, respectively, a front end of each first extending arm is bent outward and then is bent inward to form the bending portion, the two bending portions of the two elastic arms of the pressing button abut against the two blocking walls of the upper cover, a front end of each bending portion extends frontward to form the second extending arm, front ends of the two second extending arms are connected with the connecting arm of the pressing button.

3. The button structure as claimed in claim 2, wherein the pressing button defines a penetrating groove penetrating through a top surface and a bottom surface of the pressing button, the penetrating groove is formed among the two elastic arms, the connecting arm and the extending portion, two inner surfaces of the two bending portions are recessed oppositely to form two lacking grooves, each lacking groove is located between one bending portion and the extending portion of the pressing button, the two lacking grooves are communicated with the penetrating groove.

4. The button structure as claimed in claim 1, wherein the inner surface of the upper cover extends downward to form a first protrusion, the first protrusion is disposed between the two blocking walls, the connecting arm is disposed to a bottom of the first protrusion, the connecting arm abuts against the bottom of the first protrusion, a middle of a top surface of the connecting arm extends upward to form a first protruding portion, the first protruding portion abuts against the first protrusion.

5. The button structure as claimed in claim 4, wherein a front end of a bottom surface of the extending portion extends downward to form a second protruding portion, the second protruding portion of the extending portion of the pressing button abuts against the switch.

6. The button structure as claimed in claim 1, wherein the lower cover has an upper surface, a rear end of one side of the upper surface of the lower cover is recessed downward to form a first concave portion, a rear end of the main portion of the pressing button is disposed in the first concave portion, the rear end of the main portion protrudes upward to form a fastening portion, the fastening portion is disposed to the upper surface of the lower cover, the fastening portion is disposed to a top of the first concave portion.

7. The button structure as claimed in claim 6, wherein the one side of the upper surface of the lower cover is recessed downward to form a second concave portion, the second concave portion is located in front of the first concave portion, the second concave portion is communicated with the first concave portion, the main portion of the pressing button is disposed to a top of the second concave portion, a front end of a bottom wall of the second concave portion extends upward to form a stopping portion, the pressing portion of the pressing button is disposed above the stopping portion.

8. The button structure as claimed in claim 1, wherein the upper cover has a base portion and an inclining portion, one end of the base portion slantwise extends outward and downward to form the inclining portion, the inclining portion is mounted at a front of the circuit board, the base portion is mounted to a rear of the circuit board, the main portion is disposed to a bottom surface of the base portion, the two elastic arms, the connecting arm and the extending portion are disposed to a bottom surface of the inclining portion, the lower cover is mounted to the bottom surface of the base portion.

9. The button structure as claimed in claim 8, wherein the upper cover has a button hole and two location holes, the button hole penetrates through a top surface and the bottom surface of the base portion, the pressing portion is disposed in the button hole, the two location holes transversely penetrate through two opposite side surfaces of the base portion, the lower cover has an upper surface, two opposite sides of the upper surface of the lower cover extend upward to form two location portions, respectively, the two location portions are disposed in the two location holes.

10. The button structure as claimed in claim 8, wherein an inner surface of the inclining portion of the upper cover extends downward to form a first protrusion, two portions of the inner surface of the inclining portion of the upper cover extend downward to the two blocking walls, the first protrusion is disposed between the two blocking walls, two sides of an inner surface of the base portion protrude inward to form two second protrusions, the lower cover has an upper surface, the upper surface of the lower cover abuts against the two second protrusions.

11. A button structure cooperated with a circuit board, the circuit board being equipped with a switch, the button structure comprising:
an upper cover, an inner surface of the upper cover having two blocking walls;
a lower cover positioned under the upper cover; and
a pressing button disposed between the upper cover and the lower cover, the pressing button having a main portion, a front end of the main portion extending frontward to form two first extending arms, respectively, two front ends of the two first extending arms being bent outward and then being bent inward to form two bending portions, the two bending portions abutting against the two blocking walls, two front ends of the two bending portions extending frontward to form two second extending arms, a connecting arm being connected between two front ends of the two second extending arms, the connecting arm abutting against the inner surface of the upper cover, the front end of the main portion extending frontward to form an extending portion, the extending portion being positioned among the two first extending arms, the two bending portions, the two second extending arms and the connecting arm, the extending portion abutting against the switch, a top surface of the main portion protruding upward to form a pressing portion, the pressing portion projecting beyond an outer surface of the upper cover.

12. The button structure as claimed in claim 11, wherein the pressing button defines a penetrating groove penetrating through the pressing button, the penetrating groove is formed among the two first extending arms, the two bending portions, the two second extending arms, the connecting arm and the extending portion, two inner surfaces of the two bending portions are recessed oppositely to form two lacking grooves, each lacking groove is located between one bending portion and the extending portion of the pressing button, the two lacking grooves are communicated with the penetrating groove.

13. The button structure as claimed in claim 11, wherein the inner surface of the upper cover extends downward to form a first protrusion, the first protrusion is disposed between the two blocking walls, the connecting arm is disposed to a bottom of the first protrusion, the connecting arm abuts against the bottom of the first protrusion, a top surface of the connecting arm extends upward to form a first protruding portion, the first protruding portion abuts against the first protrusion.

14. The button structure as claimed in claim 13, wherein a bottom surface of the extending portion extends downward to form a second protruding portion, the second protruding portion abuts against the switch of the circuit board.

15. The button structure as claimed in claim 11, wherein the lower cover has an upper surface, a rear end of one side of the upper surface of the lower cover is recessed downward to form a first concave portion, a rear end of the main portion of the pressing button is disposed in the first concave portion, the rear end of the main portion protrudes upward to form a fastening portion, the fastening portion is disposed to the upper surface of the lower cover, the fastening portion is disposed to a top of the first concave portion.

16. The button structure as claimed in claim 15, wherein the one side of the upper surface of the lower cover is recessed downward to form a second concave portion, the second concave portion is located in front of the first concave portion, the second concave portion is communicated with the first concave portion, the main portion of the pressing button is disposed to a top of the second concave portion, a front end of a bottom wall of the second concave portion extends upward to form a stopping portion, the pressing portion of the pressing button is disposed above the stopping portion.

17. The button structure as claimed in claim 11, wherein the upper cover has a base portion and an inclining portion, one end of the base portion slantwise extends outward and downward to form the inclining portion, the inclining portion is mounted at a front of the circuit board, the base portion is mounted to a rear of the circuit board, the main portion is disposed to a bottom surface of the base portion, the two first extending arms, the two bending portions, the two second extending arms, the connecting arm and the extending portion are disposed to a bottom surface of the inclining portion, the lower cover is mounted to the bottom surface of the base portion.

18. The button structure as claimed in claim 17, wherein the upper cover has a button hole and two location holes, the button hole penetrates through a top surface and the bottom surface of the base portion, the pressing portion is disposed in the button hole, the two location holes transversely penetrate through two opposite side surfaces of the base portion, the lower cover has an upper surface, two opposite sides of the upper surface of the lower cover extend upward to form two location portions, respectively, the two location portions are disposed in the two location holes.

19. The button structure as claimed in claim 17, wherein an inner surface of the inclining portion of the upper cover extends downward to form a first protrusion, two portions of the inner surface of the inclining portion of the upper cover extend downward to the two blocking walls, the first protrusion is disposed between the two blocking walls, two sides of an inner surface of the base portion protrude inward to form two second protrusions, the lower cover has an upper surface, the upper surface of the lower cover abuts against the two second protrusions.

20. A button structure, comprising:
a main portion;
an extending portion extended frontward from a middle of a front end of the main portion;
two elastic arms extended frontward, then oppositely arched outward and further extended frontward from two opposite sides of the front end of the main portion, each elastic arm having a first extending arm, a bending portion and a second extending arm, the two opposite sides of the front end of the main portion extending frontward to form the two first extending arms of the two elastic arms, respectively, a front end of each first extending arm being bent outward and then being bent inward to form the bending portion, a front end of each bending portion extending frontward to form the second extending arm;
a connecting arm formed between two front ends of the two second extending arms of the two elastic arms; and
a pressing portion extended upward from a top surface of the main portion.
